(19) United States
(12) Patent Application Publication
(10) Pub. No.: US 2007/0245848 A1
(43) Pub. Date: Oct. 25, 2007

(54) Mounting device for the cable end piece of a bowden control

(75) Inventors: Lars Schulz, Elize (DE); Ronny Powietzka, Dassel (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Teleflex Automotive Germany GmbH

(21) Appl. No.: 11/717,687

(22) Filed: Mar. 14, 2007

(30) Foreign Application Priority Data
Mar. 15, 2006 (DE) 10 2006 012240.2

(51) Int. Cl. F16C 1/26

(52) U.S. Cl. 74/502.6

(57) ABSTRACT

The invention relates to a mounting device for a cable end piece of a bowden control, preferably for a shifting system of motor vehicles, with the mounting element being mounted to a spherical holder, comprising a damping ring (3), at which the cable end piece (2) is mounted, a housing (1) arranged inside the encircling damping ring (3) and with its exterior circumference being embodied largely cylindrically, an elastic mounting part (5) which is arranged inside the housing (1) surrounding it, with the housing (1) inside the damping ring (3) being vertically mobile and penetrating the mounting part (5) with its upper part (11), an elastic mounting part (5) being provided with a hollow space (13), a slot (7), as well as penetrations (12) for the upper part (11) of the housing (1), a narrowing existing between the housing (1) and the mounting part (5), a pressure lid (4) at the housing (1) and a spring (6) being arranged between the pressure lid (4) and the mounting part (5). The invention has the advantage that the bowden control can be mounted quickly and reliably.

The invention relates to a mounting device for the cable end piece of a bowden control according to the preamble of claim one.

The invention is suitable to mount bowden control of cable end pieces, in particular for a shifting system of motor vehicles. The invention can be used at any place bowden controls of cables for shifting systems of motor vehicles have to be connected to corresponding connection pieces of the transmission and/or the clutch. Such a connection between the bowden control and the connection pieces mounted thereto are presently designed such that the connection pieces are put or clipped onto a spherically or semi-spherically shaped element, a transmission pin, or another suitable element such that a detachable connection forms. The known connection elements are generally designed such that an elastic connection between the mounting piece and the bowden control core of the cable is provided so that a mobile connection develops. For this purpose various solutions are known in prior art.

DE 199 28 302 A1 describes a device for mounting bowden controls of cables, in which in addition to the ball socket a rubber element and an additional mass are provided to avoid oscillations. The ball socket is embodied elastically so that the bowden control can be mounted by its material, which may also be subject to tiring.

A mounting of a similar type is described in EP 0042 721 A1.

DE 197 31 039 A1 describes a device for connecting a bowden pulley to the change gear of a vehicle, in which a multi-part damping element can be clipped in a detachable manner onto a spherical mounting by its hollow space.

U.S. Pat. No. 5,220,832 describes a mounting device, by which cables are mounted on a spherical fastener, providing the possibility by which engaging teeth vary the length of the cable.

A damped device of the above-mentioned type is described in DE 695 06 313 T2.

DE 10 2004 013 193 A1 describes a connection device for an operating pulley to a user, comprising a base and an accepting body for connecting to a user, with the accepting body being supported, in a linearly displaceable manner in the direction of the longitudinal axis of the base, in a guidance at the base and at least one damping element being arranged stressed essentially only in the direction of the longitudinal axis between the receiving body and the basic body.

From U.S. Pat. No. 5,265,495 a mounting device for bowden controls is discernible in which several parts can be placed subsequently onto the spherical connection that must be separated consecutively in case of detachment.

All mounting devices for bowden controls of prior art comprise either a multitude of parts and create a complicated connection, which is disadvantageous in case of a quick assembly, or the connection is based on the presence of an elastic material in a ball socket, creating the connection, but leading to a loosening when the material tires, which results in an unreliable connection.

Therefore, the object of the invention is to provide a connection device for bowden controls, which can be closed with little expense and which has a high degree of reliability with regard to an unintended loosening.

This object is attained in a mounting device according to the features of claim one.

Sub claims show advantageous embodiment variants of the invention.

The solution according to the invention provides for a mounting device for a bowden control of the cable end piece, with the mounting device being fastened on a spherical or semi-spherical element. The cable end piece to be fastened is arranged at a ring, preferably a damping ring. The damping ring encircles a housing, which can be moved up and down inside of it. The housing comprises bars in its upper part. It is advantageous for the housing to comprise four individual bars in its upper part. A pressure lid is arranged at these bars. It is advantageous for the pressure lid and the housing to be made in two separate parts. Furthermore it is advantageous when the housing has a stop towards the bottom. This stop can advantageously be embodied in a cylinder shape. Furthermore it is advantageous for the housing to be made from plastic.

A mounting part is arranged inside the housing. Between the housing and the mounting part there is a wedge-shaped enlargement. It can either be arranged on the housing or on the mounting part. An arrangement on the housing is advantageous, in which it is embodied with an increasing wall thickness downwards. By the wedge-shaped enlargement of the housing the mounting part is compressed by the motion of the housing. This conditions that the mounting part has a slot, which narrows by the compression. By the narrowing of the slot the mounting part tightly closes around a spherical or semi-spherical element, at which the mounting device is to be mounted and remains closed until the housing is moved to a different position.

The elastic mounting element, which is provided at its interior with a hollow space, has perforations penetrated by the upper parts of the housing. It is advantageous for four upper parts of the housing to penetrate four perforations of the mounting part. Here, it is further advantageous to embody these perforations in an oblong fashion.

A spring is arranged between the pressure lid and the mounting part, with its pressure constantly pulling the housing against the mounting part so that it cannot open unintentionally. When opening is desired an assembling person can press the pressure lid against the force of the spring resulting in the mounting element to open as soon as the housing is pressed downwards and the mounting device can be taken off. A mounting of the mounting device occurs in the same manner, by pressing the pressure lid downwards against the force of the spring, which leads to the opening of the mounting part, and subsequently the mounting device can be put onto it and after the loosening of the pressure lid the force of the spring automatically reseals it.

Furthermore it is advantageous for the elastic mounting part to be made from plastic, in particular PTFE. It is further advantageous to centrally provide a hole in the mounting part so that air can exhale from the part in case of a quick placement.

The device according to the invention is advantageous in that it can be produced in a simple manner and the cable end pieces can be assembled and disassembled quickly and reliably onto spherical and semi-spherical elements, creating a reliable connection.

In the following the invention is explained in greater detail using eleven figures and an exemplary embodiment. The figures show:

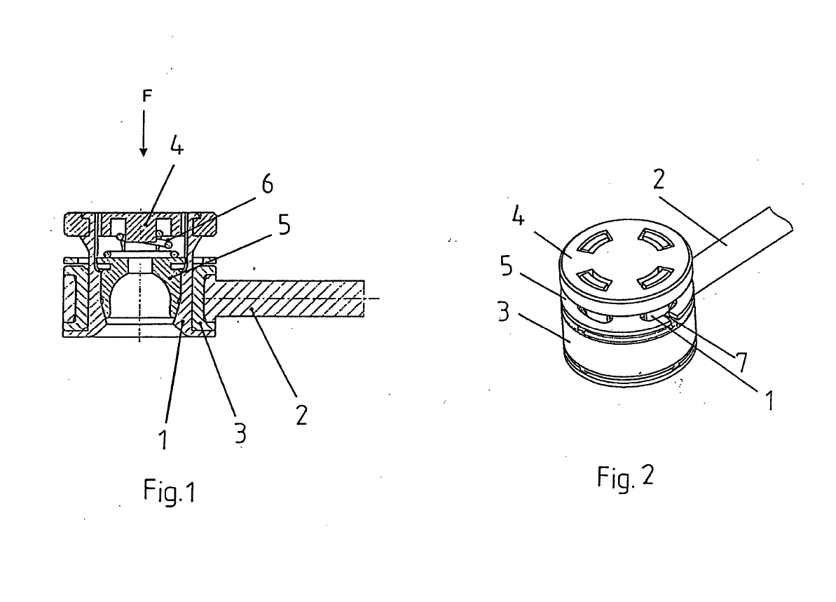

FIG. 1: a cross-section through the mounting device

FIG. 2: a mounting device in a perspective representation

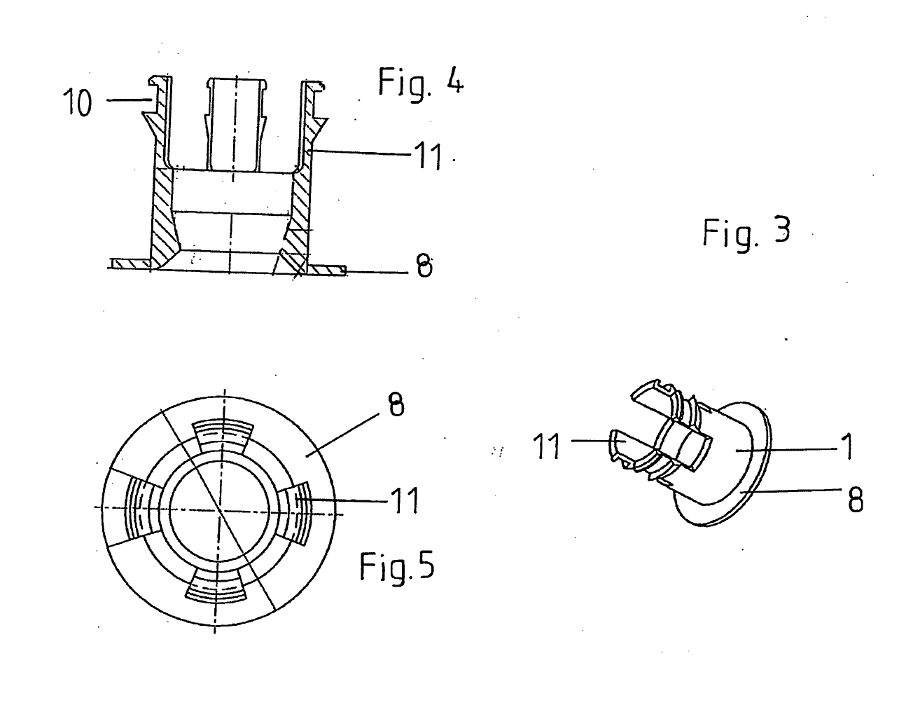

FIG. 3: a housing in a perspective representation

FIG. 4: a housing in a cross-section

FIG. 5: a housing in a top view

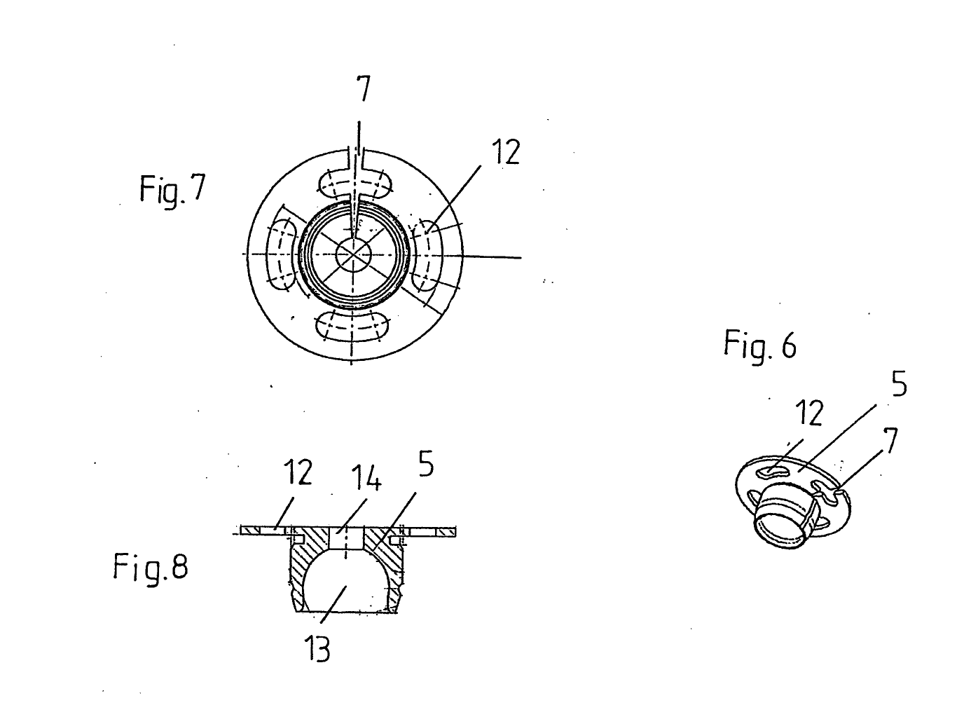

FIG. 6: a mounting part in a perspective representation

FIG. 7: a mounting part in a top view

FIG. 8: a mounting part in a cross-section

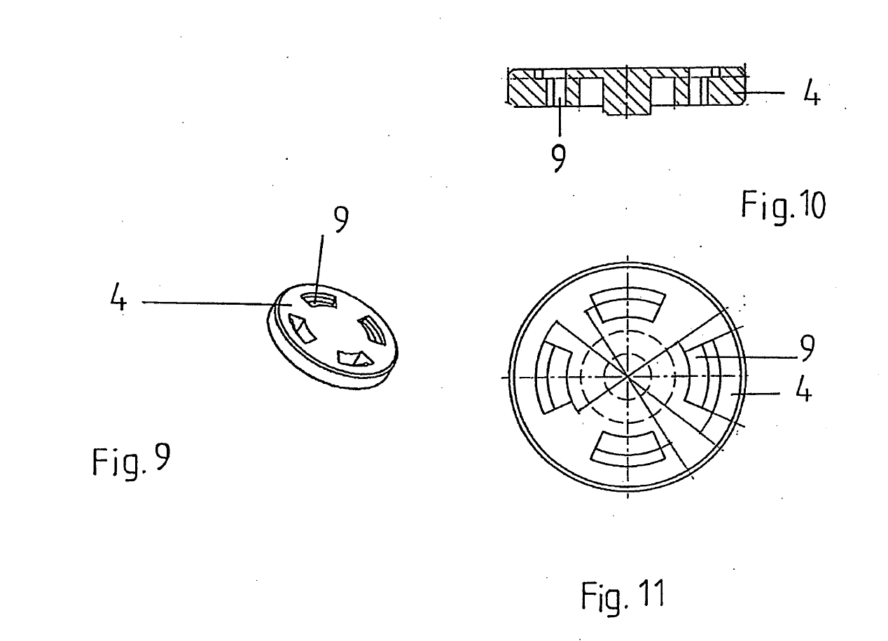

FIG. 9: a pressure lid in a perspective representation

FIG. 10: a pressure lid in a cross-section

FIG. 11: a pressure lid in a top view.

FIG. 1 shows the mounting device for a bowden control in a cross-section, comprising a housing 1, which has in its lower part a conical narrowing and which in its upper part carries a pressure lid 4. The pressure lid 4 and the housing 1 represent two parts, which are mounted. Inside the housing 1 the mounting part 5 is arranged, which is compressed by the wedged shape of the housing 1. The spring 6 is arranged between the mounting part 5 and the pressure lid 4, which ensures that the mounting part 5 remains closed as long as no force F acts upon the pressure lid 4. As soon as a force F acts upon the pressure lid 4 the housing 1 is pushed downwards so that the mounting element 5 can open by its elastic stress. This way the mounting device can be placed onto a spherical part or taken off. The housing 1 is surrounded by a damping ring 3, at which the cable end piece 2 is mounted. At both sides of the narrowing, downwards and upwards, the interior diameter of the housing 1 gets larger.

FIG. 2 shows the mounting device in a perspective representation. In this particular embodiment four openings 9 are arranged in the pressure lid 4. The housing 1 penetrates the openings of the mounting part 5, which has a slot 7, with four upper parts. The housing 1 is further surrounded by the damping ring 3, at which the cable end piece 2 is arranged.

FIGS. 3, 6, and 9 show the parts housing 1, mounting part 5, and pressure lid 4 in a perspective representation of a preferred embodiment variant. The housing 1 has as its lower limit 8 a circular shape and is embodied in its upper part 11 in four individual parts, having a recess 10 for the pressure lid 4, as discernible from FIGS. 3 and 4. In order for the pressure lid 4 to snap in a formfitting and reliable manner in these recesses 10, penetrations 9 are arranged at the pressure lid 4, shaped such that the recesses 10 can engage here, which is discernible from FIGS. 9, 10, and 11.

The mounting part 5, which can wrap with its hollow space 13 around a spherical element, is provided with a gap 7, which opens when the pressure lid 4 is pressed downwards and the housing 1 is opened by the innate stress of the mounting part 5, and which is shown in FIGS. 7, 5, and 2. Advantageously a hole 14 (FIG. 8) is located in the mounting part 5, through which air can exhale. Oblong perforations 12 allow a penetration of the upper part 11 of the housing 1.

The device can be mounted in a simple manner and be used to quickly and reliably mount cables to transmission or clutch parts of motor vehicles.

List of character references used

1 housing

2 cable end piece

3 damping ring

4 pressure lid

5 mounting part

6 spring

7 slot in 5

8 lower limit of 1

9 penetration of the pressure lid 4

10 recess in 1 for the pressure lid 4

11 upper part of 1

12 penetration in 5

13 hollow space in 5

14 opening in 5

1. A mounting device for the cable end piece of a bowden control, preferably for a shifting system of motor vehicles, with the mounting device being mounted to a spherical holder, comprising a damping ring at which the cable end piece is mounted, a housing, which is arranged inside a surrounding damping ring and largely being embodied cylindrical at its exterior circumference, an elastic mounting element arranged inside the housing surrounding it, with the housing being vertically mobile inside the damping ring and penetrating the mounting element with its upper part, the elastic mounting element having a hollow space, a slot, as well as penetrations for the upper part of the housing, a narrowing between the housing and the mounting part being provided, a pressure lid being arranged at the housing and a spring between the pressure lid and the mounting part.

2. A mounting device according to claim 1, wherein the housing is provided in its lower interior part with a narrowing and then tapers in a cone-shaped manner inwardly.

3. A mounting device according to claim 1, wherein the housing comprises four individual bars in its upper part.

4. A mounting device according to claim 3, wherein a recess is arranged at each bar for the pressure lid.

5. A mounting device according to claim 4, wherein the housing is provided with a disk-shaped collar at the bottom.

6. A mounting device according to claim 5, wherein the housing is made from plastic.

7. A fastening device according to claim 1, wherein the pressure lid is provided with oblong penetrations.

8. A mounting device according to claim 7, wherein penetrations are embodied for snapping the upper part of the housing.

9. A mounting device according to claim 1, wherein oblong-shaped penetrations are embodied in the mounting part.

10. A mounting device according to claim 1, wherein four penetrations are arranged in the mounting part.

11. A mounting device according to claim 1, wherein a mounting part is made from plastic.

12. A mounting device according to claim 1, wherein the mounting part is made from PTFE.

13. A mounting device according to claim 1, wherein a hole is arranged in the middle of the mounting part.
